(19) United States
(12) Patent Application Publication
(10) Pub. No.: US 2015/0113480 A1
(43) Pub. Date: Apr. 23, 2015

(54) USER INTERACTION SYSTEM FOR DISPLAYING DIGITAL OBJECTS

(71) Applicant: OCE-TECHNOLOGIES B.V., Venlo (NL)

(72) Inventors: Nanne KRIKKE, Nijmegen (NL); Jacoba A. H. JANSEN, Venlo (NL); Floortje MATTHEIJSSEN, Venlo (NL)

(73) Assignee: OCE-TECHNOLOGIES B.V., Venlo (NL)

(21) Appl. No.: 14/579,534

(22) Filed: Dec. 22, 2014

Related U.S. Application Data
(63) Continuation of application No. PCT/EP2013/061783, filed on Jun. 7, 2013.

(30) Foreign Application Priority Data
Jun. 27, 2012 (EP) 12173731.6

(51) Int. Cl. G06F 3/0485; G06F 3/0482; G06K 15/00; G06F 3/0481

(52) U.S. Cl. CPC G06F 3/0485; G06F 3/04817; G06F 3/0482; G06K 15/007
USPC 715/830

(57) ABSTRACT

A user interaction system includes a control for controlling digital objects characterized by a first content level. Each said digital object includes at least one digital object characterized by a second content level. A display for displaying the digital objects by means of thumbnail images is arranged to show under control of the control a first scrollable list of at least one selectable thumbnail image, each of which represents a digital object characterized by a first content level on the display, and a second scrollable list of at least one selectable thumbnail image, each of which represents a digital object characterized by a second content level on the display. The control is configured to show the first scrollable list on the display and to show, upon selection of a thumbnail image of the first scrollable list, simultaneously with the first scrollable list, the second scrollable list corresponding to the at least one digital object characterized by the second content level included in the digital object characterized by the first content level corresponding to the selected thumbnail image.

### CROSS-REFERENCE TO RELATED APPLICATIONS

This application is a Continuation of International Application No. PCT/EP2013/061783, filed on Jun. 7, 2013, and for which priority is claimed under 35 U.S.C. § 120. PCT/EP2013/061783 claims priority under 35 U.S.C. § 119(a) to Application No. 12173731.6, filed in Europe on Jun. 27, 2012. The entire contents of each of the above-identified applications are hereby incorporated by reference into the present application.

### BACKGROUND OF THE PRESENT INVENTION

1. Field of the Present Invention

The present invention relates to a user interaction system comprising a control for controlling digital objects of a first content level, the digital objects comprising at least one digital object of a second content level; and a display for displaying the digital objects of the first content level and the second content level by means of thumbnail images, said display being configured to display under control of the control: a first scrollable list of at least one first selectable thumbnail image, each of the at least one first selectable thumbnail image representing a digital object of a first content level; and a second scrollable list of at least one second selectable thumbnail image, each of the at least one second selectable thumbnail image representing a digital object of a second content level. A digital object of a first content level is also named a first content level digital object in this application. A digital object of the second content level is also named a second content level digital object in this application.

2. Description of Background Art

User interaction systems are known, which have menu structures comprising a plurality of cascading lists of item names. A first scrollable list comprises function names of a first level. Each function name of the first scrollable list is selectable by a mouse click or other indicating device, like a tap or swipe of a human finger or a stylus, in case of a touch screen. When a function name is selected from the first scrollable list, a second scrollable list of names of sub-functions belonging to the selected function appears. Each sub-function name in its turn is selectable. The first scrollable list may contain so many function names that the first scrollable list is shown accompanied by a scroll bar for making the first scrollable list scrollable. The same implementation may apply for the second scrollable list

When a sub-function name is selected, a sub-function, which is coupled to the sub-function name is executed by a control of the user interaction system.

Reproduction systems are known, which have a local user interface or a mobile interface. The local user interface may be attached to the reproduction system. The mobile interface may be wirelessly connected to the reproduction system. The local user interface and the mobile interface comprise a display for displaying a list of selectable print jobs representing a queue of print jobs submitted to the reproduction system. The display may be a touch screen, which enables the use of single-touch or multi-touch gestures for manipulating thumbnail images. Thumbnail images are reduced-size versions of pictures, used to help in recognizing and organizing them, serving the same role for images as a normal text index does for words. Each print job in a queue of print jobs may be represented by a thumbnail image of a first page of a document corresponding to the print job.

### SUMMARY OF THE PRESENT INVENTION

Touch screen usage enables the introduction of gestures for manipulating such a list of thumbnail images. The user interaction system according to the present invention takes advantage of the properties of such a touch screen. According to the present invention, the control is configured to issue a display command to the display to show the first scrollable on the display and to show, upon selection of a thumbnail image of the first scrollable list, simultaneously with the first scrollable list, the second scrollable list corresponding to the at least one digital object of the second content level, the at least one digital object of the second content level being included in the digital object of the first content level and corresponding to the selected thumbnail image. Because the first scrollable list and the second scrollable list are simultaneously in view of the user, it is easy to switch from selecting a digital object via the first scrollable list to selecting a digital object via the second scrollable list and vice versa.

According to an embodiment, the first scrollable list and the second scrollable list are scrollable by means of a swiping gesture. The first scrollable list and the second scrollable list comprise thumbnail images of the digital objects. Since the thumbnail images have a substantial size, it is possible to swipe with a finger or other swiping tool through a plurality of digital objects represented in the first scrollable list, which are ordered in a line at the display.

According to an embodiment, a first direction of scrolling through the first scrollable list and a second direction of scrolling through the second scrollable list have a same orientation. The first scrollable list and the second scrollable list may be displayed parallel to each other. The second scrollable list may comprise the digital objects that are comprised in the digital object that corresponds to a selected digital object of the first scrollable list. A digital object of the first or second scrollable list may be considered selected if the corresponding thumbnail image is highlighted or at a certain position at the display, for example in the middle of a longitudinal axis of the first scrollable list at the display. The first scrollable list and the second scrollable list may be positioned parallel and adjacent on the display.

According to an embodiment, a first direction of scrolling through the first scrollable list and a second direction of scrolling through the second scrollable list have different orientation, and the second scrollable list, when shown, crosses the first scrollable at the thumbnail image selected from the first scrollable list. The first direction may be perpendicular to the second direction. The crossing of the first scrollable list and the second scrollable list may be displayed in such a way that the second scrollable list. When shown, overlaps the first scrollable list so that the thumbnail image selected from the first scrollable list is not visible at the display. According to another embodiment, the crossing of the first scrollable list and the second scrollable list may be displayed in such a way that the first scrollable list is visible at the crossing and the second scrollable list is split at the crossing.

According to an embodiment, a thumbnail image is selected from the first scrollable list by swiping at the thumbnail image in the second direction. A swiping gesture in the first direction at a thumbnail image of the first scrollable list activates a scrolling through the first scrollable list. A swiping gesture at a thumbnail image of the first scrollable list in the second direction activates a selection of the touched thumbnail image and an appearing of the second scrollable list of thumbnail items corresponding to the second content level digital objects included in the first content level digital object that is represented by the selected thumbnail image of the first scrollable list.

According to an embodiment, the control is configured to issue a display command to the display in order to hide the second scrollable list when scrolling through the first scrollable list. When a second scrollable list is already shown at the display, the user may want to scroll through the first scrollable list in order to select another thumbnail image of the first scrollable list. To overcome a display crowded with thumbnail items previously shown upon selection, the control issues a display command to the display in order to hide the second scrollable list belonging to a previously selected thumbnail image of the first scrollable list.

According to an embodiment, each digital object characterized by the first or second content level is one of a set of digital documents, a digital document, a chapter of a digital document and a page of a digital document.

In a first example, the digital object characterized by the first content level is a set of digital documents and the at least one digital object characterized by the second content level is a digital document out of the set of digital documents. The set of digital documents may be a print mailbox of a particular user of a reproduction system connected to the user interaction system. The set of digital documents may be a daily set of documents to be printed on a reproduction system connected to the user interaction system. The set of digital documents may be a source environment, such as a collection of print mailboxes, an internal network location, an external service facility, e.g. a digital cloud facility, a set of last used documents, an external FTP connection digital source, or a USB source, connectable to the control unit.

In a second example, the digital object characterized by the first content level is a digital document, e.g. a digital document in a queue of a reproduction system connected to the user interaction system, and the at least one digital object characterized by the second content level is a chapter of the digital document.

In a third example the digital object characterized by the first content level is a digital document, for example in a queue of a reproduction system, and the at least one digital object characterized by the second content level is a page of the digital document.

According to an embodiment, the first content level of each digital object and the second content level of an at least one corresponding digital object are selected out of more than two content levels. A hierarchy of content levels may be used to show digital objects of a pair of content levels. Two content levels may be shown that are subsequent in the hierarchy, for example according to a parent-child relationship.

According to a further embodiment, an orientation of showing lists of at least one thumbnail image alternates with respect to a subsequent content level of the thumbnail images. This is especially suitable when thumb nail images corresponding to more than two content levels are displayed.

The present invention also relates to a reproduction system comprising a user interaction system according to any of the previous embodiments and a print engine that is controlled by the control of the user interaction system and is configured to reproduce the digital objects. The reproduction system may comprise workstations connected to a local network. The present invention is particularly suited for use in this kind of environment, Where a reproduction system is available for a user working with one of the workstations and intending to send a print job comprising a set of documents from one of the workstations to the reproduction system. The reproduction system is connected to the network and suited for receiving print jobs from the workstations. The network may be wireless. The reproduction system comprises the user interaction system, which is suitable for displaying and selecting print jobs and their settings. The print engine may be able to print small and/or wide format documents.

The user interaction system may be mounted on top of the reproduction system, may be integrated in a front panel of the reproduction system or may have a touch screen mounted on top of the reproduction system.

The present invention also relates to a method for scrolling through thumbnail images on a display of a user interaction system, each thumbnail image representing a digital object characterized by a content level out of a plurality of content levels, said method comprising the steps of: displaying a first scrollable list of thumbnail images representing digital objects characterized by a first content level, each digital object comprising at least one digital object characterized by a second content level: selecting a digital object from the first scrollable list by means of a user gesture at the first scrollable list: and displaying simultaneously with the first scrollable list a second scrollable list of at least one thumbnail image corresponding to the at least one digital object characterized by the second content level, said at least one digital object corresponding to the selected digital object.

The present invention also relates to computer executable program embodied on a non-transitory computer readable medium and configured to instruct a computer to perform a method according to the method of the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1A-1B are diagrams, each illustrating a configuration of a user interaction system;

FIG. 2 illustrates a configuration of a user interaction system integrated in a reproduction system;

FIG. 3 illustrates an embodiment of a user interaction system, when showing the first scrollable list of thumbnail images;

FIG. 4 illustrates a display of a user interaction system, when showing the first scrollable list of thumbnail images and the second scrollable list of thumbnail images in a same orientation;

FIG. 5 illustrates the display, when showing the first scrollable list of thumbnail images in the first orientation and the second scrollable list of thumbnail images in a second orientation;

FIG. 6 illustrates the display of a user interaction system, when showing the first scrollable list of thumbnail images in the first orientation and the second scrollable list of thumbnail images in a second orientation;

FIG. 7 illustrates a diagram of hierarchical content levels of digital objects;

FIG. 8 illustrates an example of simultaneously displaying lists of three content levels;

FIG. 9 is a flow diagram of an embodiment of the method according the present invention; and

FIG. 10 illustrates a working area of a swiping gesture at a digital object.

### DETAILED DESCRIPTION OF THE PREFERRED EMBODIMENTS

The present invention will now be described with reference to the accompanying drawings, wherein the same reference numerals have been used to identify the same or similar elements throughout the several views.

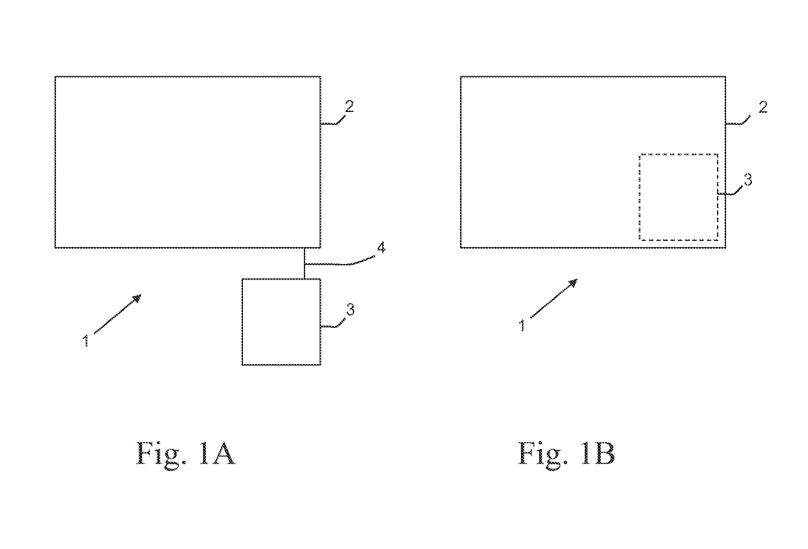

FIGS. 1A-1B illustrate a user interaction system 1 comprising a display 2 connected to the control 3, e.g. a computer system with processor and memory. The control 3 may be integrated with the display 2 in a single housing as shown in FIG. 1B. The user interaction system 1 in FIG. 1B may be a mobile device, which is wirelessly connected to a control unit of a printing apparatus. The display 2 may be a touch screen. The control 3 may be connected to the display 2 by a connection 4 which may be wired or wireless as shown in FIG. 1A. The display in FIG. 1A may be a mobile device. The mobile device may he a mobile phone, a tablet personal computer, a notebook computer or the like.

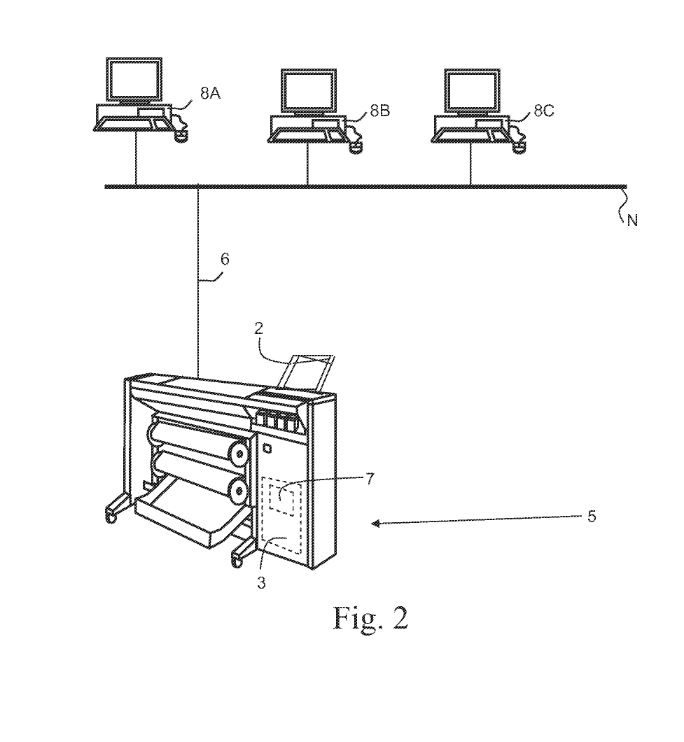

FIG. 2 illustrates the user interaction system integrated in a reproduction system 5, for example a multifunctional printer, a small format printer or a wide format printer. The reproduction system 5 is available via a network connection 6 for a user working with workstations 8A, 8B, 8C, which are connected via a network N. The user may send a print job comprising a set of documents from the workstation 8A, 8B, 8C to the control 3 of the reproduction system 5. The control 3 comprises a storage device 7 for storing the print job. The display 2 is suitable for displaying print jobs by means of a scrollable list of thumbnail images representing the print jobs and for selecting a print job by selecting a thumbnail image from the scrollable list.

According to an embodiment, the control 3 may be suited to queue print jobs, to check whether or not the print queue is empty and to submit a document from a queued print job to the print engine of the reproduction system 5 in order to be printed. The control 3 comprises a storage device 7 for storing documents of a print job at least for the time period that ends after the document is completely printed by the reproduction system 5. When a print job arrives at the reproduction system 5 according to FIG. 2, it is stored in the control 3.

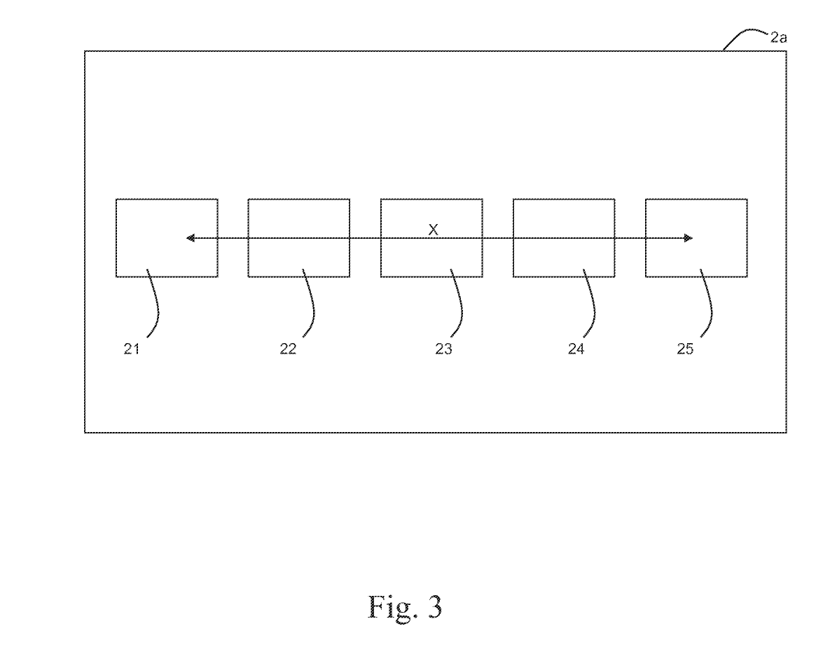

FIG. 3 illustrates a display part 2a of the display 2 according to FIG. 1A and FIG. 2, when showing the first scrollable list of thumbnail images 21-25. The display 2 is a touch screen and the connected control 3 comprises a computer program to enable the display 2 to recognize gestures operated upon the touch screen and to execute actions like adaptation of the displayed list of thumbnail images 21-25 according to the recognized gestures.

The computer program makes the list scrollable via a gesture by a stylus or a human finger. The gesture may be in an approximate direction of the longitudinal axis of the list of thumbnail images 21-25 indicated by a double sided arrow X. The gesture may be a swiping gesture. Before a gesture is applied on the touch screen, the thumbnail images 21-25 are visible at the touch screen. After the gesture is applied, the list of thumbnail images 21-25 is shifted in a direction of one end of the double sided arrow X corresponding to the direction of the applied gesture. A first thumbnail image 21 is not visible any more on the screen after a gesture from right to left in a direction of the X orientation, while a sixth thumbnail image (not shown) may appear on the right side of the screen.

A thumbnail image may be selected by a gesture, touch, tap or click on the thumbnail image. A thumbnail image may be default selected when the thumbnail image is positioned in the middle of the display part 2a. In FIG. 3, the third thumbnail image 23 may be default selected. In order to indicate that a thumbnail image is selected, it may change its appearance, like its color or its shape. The velocity of a gesture is measured by the touch screen 2 in combination with the connected control 3. The measured velocity of a gesture may be used to determine how many thumbnail images appear and disappear on the display part 2a when the gesture is applied.

A thumbnail image is based on image information as contained in the digital object as it has been received by the control. The image information may also be scanned and stored by a reproduction apparatus. Settings that have been used to create or generate the digital object are taken into account for the display of the thumbnail image. Such settings may an original type and color mode, a removal of a leading or trailing strip, an orientation of the object, a finishing option, etc.

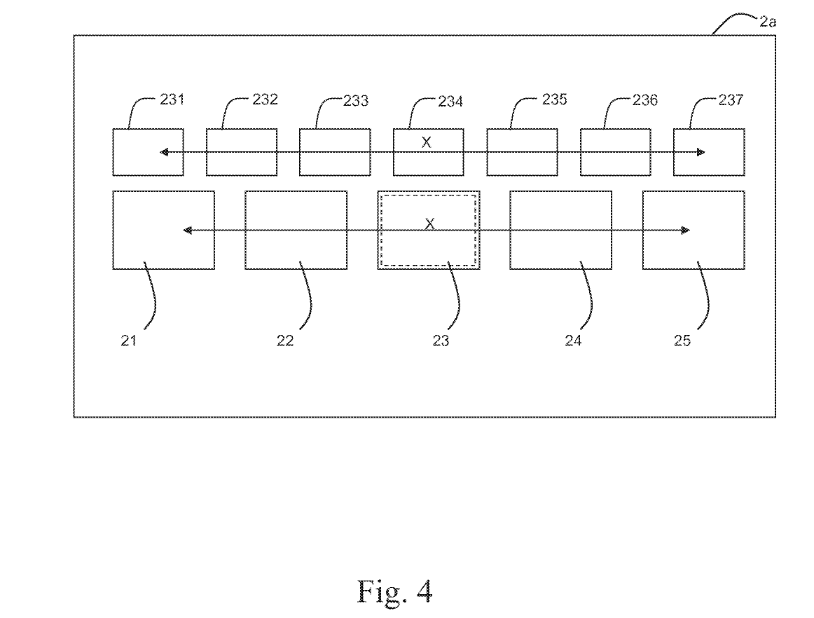

FIG. 4 illustrates the display part 2a of the display, when showing the first scrollable list of thumbnail images 21-25 and the second scrollable list of thumbnail images 231-237 in a same orientation X. The second scrollable list may appear after a thumbnail image is selected from the first scrollable list or after a gesture is applied to the first scrollable list. If a thumbnail image is default selected from the first scrollable list, the second scrollable list may be visible whenever the first scrollable list is visible.

In FIG. 4, the third thumbnail image 23 of a digital object of a first content level is selected. The digital objects of the second content level, which belong to the digital object of the first content level, are represented by the second scrollable list of thumbnail images 231-237. The second scrollable list is also scrollable by means of a gesture.

According to an embodiment, which is shown in FIG. 4, the second scrollable list is positioned adjacent to the first scrollable list. This is advantageous, since the user can see at one glance the first and second scrollable list. After selecting another thumbnail image than the third thumbnail image 23 from the first scrollable list, the second scrollable list is adapted and shows thumbnail images corresponding to the digital object of the second content level belonging to the digital object of the first content level corresponding to the other selected thumbnail image. Sizes of the thumbnail images are chosen arbitrarily and may be varied. The number of thumbnail images to be displayed at the display may also being varied and may depend on the size of the thumbnail images and also the size of the display part 2a of the display.

According to an embodiment, the control is configured to display a second scrollable list, when a first thumbnail image of the first scrollable list is selected, and upon selection of a second thumbnail item of the second scrollable list, the first thumbnail image in the first scrollable list changes into the second thumbnail image of the second scrollable list.

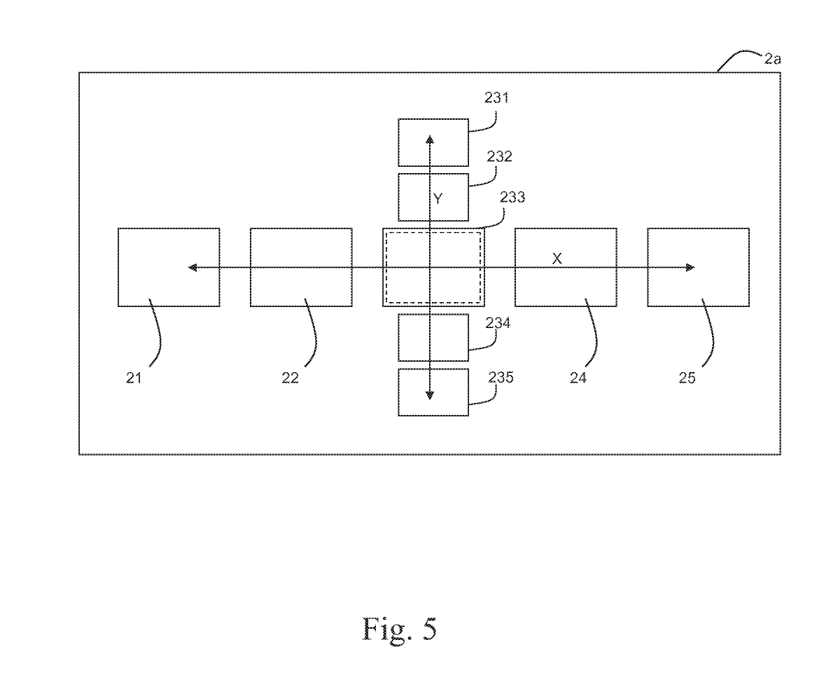

FIG. 5 illustrates the display part 2a of the display, when showing the first scrollable list of thumbnail images 21-25 in the first orientation X and the second scrollable list of thumbnail images 231-235 in a second orientation Y. The second scrollable list of thumbnail images 231-235 corresponds to the selected third thumbnail image (not shown) of the first scrollable list, The second scrollable list of thumbnail images 231-235 is scrollable in the second orientation Y. Scrolling may be achieved by tapping or clicking, by applying a gesture like a swiping gesture, etc. In the shown embodiment, the second scrollable list of thumbnail images 231-235 is not interrupted by the first scrollable list. In this way the selected thumbnail image 23 of the first scrollable list is not visible after appearance of the second scrollable list. If the selected thumb nail image of the first scrollable list is equal to a thumb nail image of the second scrollable list of thumb nail images 231-235, for example the thumb nail image 231, it is nevertheless visible. In another embodiment, the second scrollable list of thumbnail images 231-235 is interrupted by the first scrollable list, for example between a second thumbnail image 232 of the second scrollable list and a third thumbnail image 233 of the second scrollable list. In this way, the selected thumbnail image 23 of the first scrollable list is still visible after appearance of the second scrollable list.

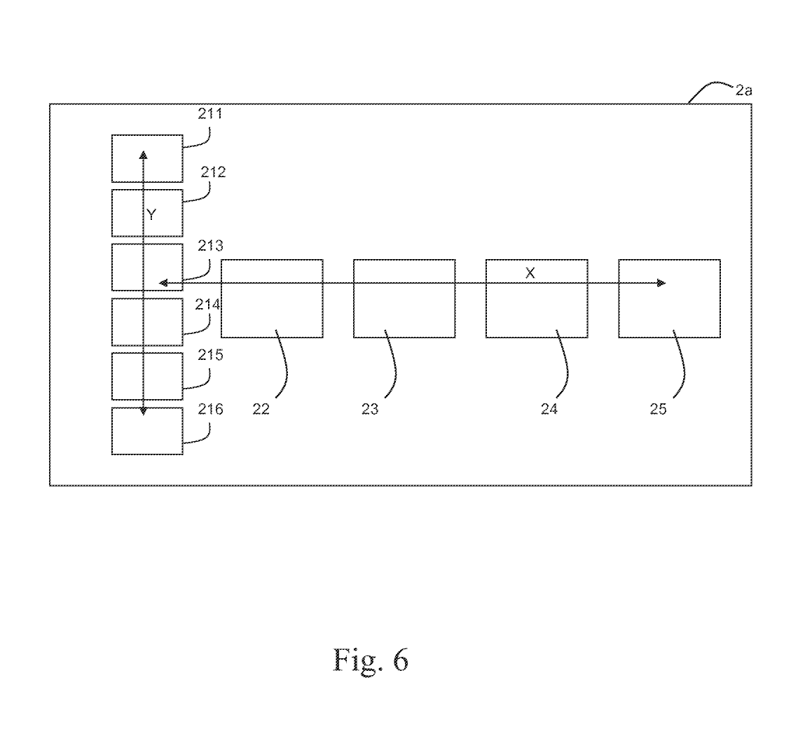

FIG. 6 shows another embodiment of a second scrollable list appearance. The second scrollable list of thumbnail images 211-216 appears after a selection of or a swiping gesture action at the first thumbnail image 21 of the first scrollable list. Contrary to FIG. 5, the second scrollable list is not interrupted, but the first scrollable list is interrupted by leaving the selected thumbnail image 21 of the first scrollable list out. Since the second scrollable list is not interrupted any more, two more thumbnail images 215, 216 of the second scrollable list are visible at the display part 2a.

Initially, only the first scrollable list may be visible, After the user has applied a swiping gesture in a direction of the second orientation Y at a thumbnail image from the first scrollable list, the second scrollable list may appear as shown in FIG. 6. According to FIG. 6, the swiping gesture has been applied to the first thumbnail image 21 of the first scrollable list. The swiping gesture may be applied to any visible thumbnail image 21-25 of the first scrollable list. When a second scrollable list belonging to a thumbnail image of the first scrollable list is already visible, the second scrollable list disappears as soon as another thumbnail image of the first scrollable list is selected or swiped at in a direction of the Y orientation.

After the selection of or swiping gesture action in a direction of the Y orientation at the other thumbnail image, a second scrollable list belonging to the other thumbnail image appears in the Y orientation. Also, when scrolling through the first scrollable list in a direction of the X orientation, the second scrollable list may disappear until thumbnail image of the first scrollable list is selected again.

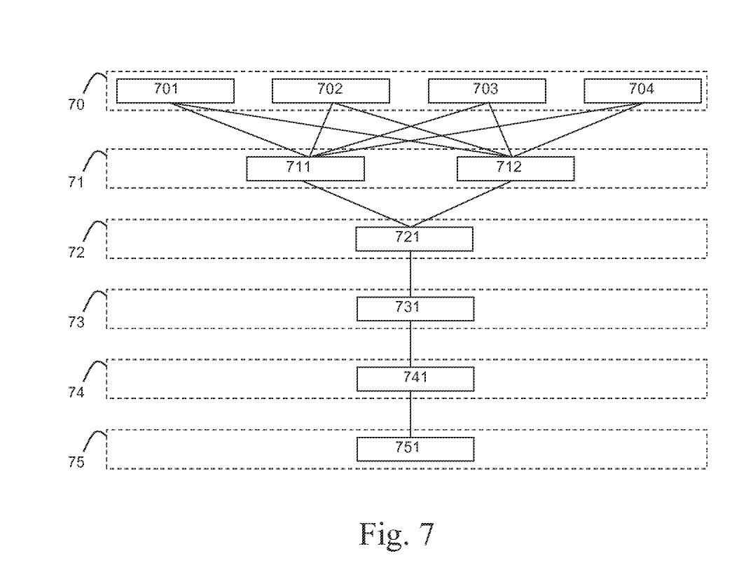

Content levels of digital objects may be used to hierarchically classify the digital objects to be displayed. FIG. 7 illustrates an example of a hierarchical classification of digital objects. This classification relates to digital objects that are used by a reproduction system such as a printer. A zero content level is a highest hierarchy level 70, which is a digital source that comprises digital documents. A first digital source 701 is a collection of print mailboxes stored in the control unit. A second digital source 702 is an internal network location of at least one server. A third digital source 703 is an external service facility, e.g. a digital cloud facility. A fourth digital source 704 is a USB source connectable to the control unit. Other digital sources may be envisioned such as a set of last used documents, a set of “My Documents”, or a set of FTP externally enabled digital sources. The digital objects at each of the digital sources may reside outside the control unit but is always reachable by the control unit, e.g. via a digital network between the digital source and the control unit.

The control unit of a printer has storage locations for each user of the printer, also known as a print mailbox 711. The storage locations of the control unit of the printer may be arranged in sets 712 corresponding to predetermined time periods of arrival of print jobs at the reproduction system. The predetermined time period 712 may be a day, a week, month, etc. Such a user mailbox 711 or such a set 712 of a predetermined time period may be a first content level 71 below the highest hierarchy level 70 and may be a child of at least one of the digital sources 701, 702, 703, 704. Below the first content level 71, a second content level 72 may be related to the print jobs 721 belonging to the first content level. Below the second content level 72, a third content level 73 may be conceived as the documents 731 to be printed according to a print job. Below the third content level 73, a fourth content level 74 may be conceived as the chapters 741 of a document to be printed. Below the fourth content level 74, a fifth content level 75 may be conceived as the pages 751 of a chapter of a document to be printed. Digital objects corresponding to two different hierarchical levels out of the total of hierarchical levels 71, 72, 73, 74, 75 may be displayed as a first scrollable list of thumbnail images and a second scrollable list of thumbnail images. A content level may be skipped in a representation by the first and second scrollable list, For example, the first scrollable list may represent the user mailboxes 711, period sets 712 of the first content level 71, while the second scrollable list represents the documents 731 of the third content level 73 belonging to each user mailbox. The control may be configurable by setting which hierarchical content levels are to be displayed and what is the maximum number of different content levels to be displayed.

To identify each thumbnail image of a list of thumbnail images, the thumbnail image may be accompanied by an identifying text. The text may also be part of the thumb nail image. For example, documents may be identified by a thumb nail image comprising the text “Doc1,” “Doc2,” etc., respectively. If, for example, a document is identified by a thumb nail image comprising the text “Doc1” and comprises 5 pages in total, a third page of the document may be identified by a thumb nail image comprising the text “Doc1, page 3 of 5.” Identification of an object on an arbitrary content level like QR codes, bar codes, signatures, abbreviations, natural numbers, combinations of digits and letters or other ways of identification that are conceivable by the skilled person to be suitable to be combined with a thumbnail image, are also within the scope of the present invention.

As an example, in order to show arrived print jobs at the display in the first scrollable list, each print job is represented by a thumbnail image. The thumbnail image may be used by a user to recognize the print job. According to an embodiment, the thumbnail image is representing a first document in the print job, for example the thumbnail image is an image of the first page of the first document in the print job. In case of a plurality of print jobs, the corresponding thumbnail images are ordered in one direction at the display so as to form a first scrollable list of thumbnail images. The first scrollable list of the thumbnail images may be sequenced by the arrival times of the corresponding print jobs at the reproduction system.

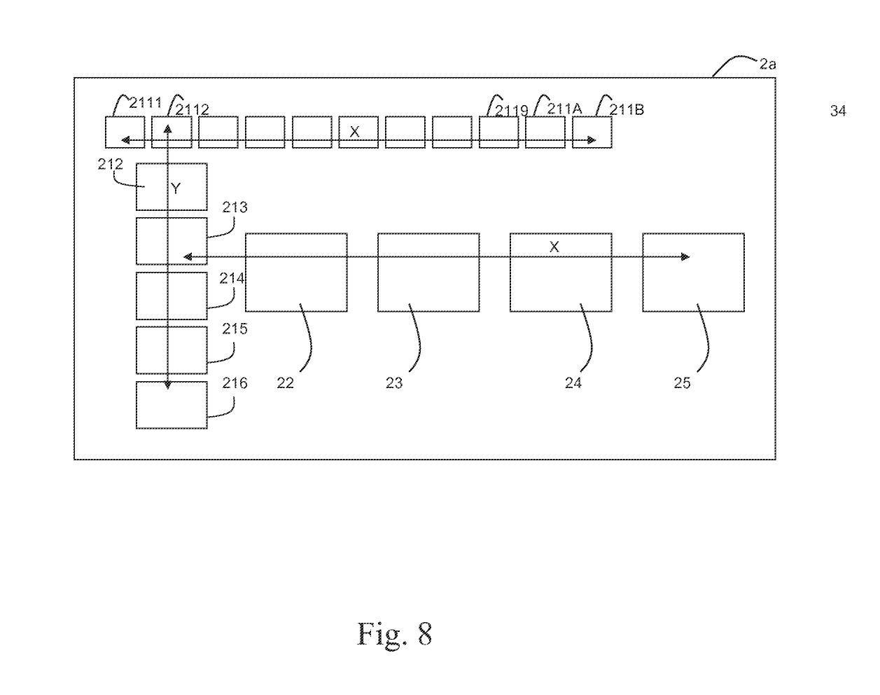

FIG. 8 illustrates an example of simultaneously displaying lists of three content levels. According to an embodiment, the first content level of each digital object and the second content level of an at least one corresponding digital object are selected out of more than two content levels. The hierarchy of content levels may be used to show digital objects of a triple of content levels or a n-fold of content levels, where n is a natural number greater than 3. A first scrollable list of digital objects 22-25 of a first content level is shown, except the first digital object 21, which is not shown because it is selected from the first scrollable list. Therefore, a second scrollable list of digital objects 212-216 of a second content level is shown, except the first digital object 211, which is not shown because it is selected from the second scrollable list. Therefore, a third list of eleven digital objects 211-211B of a third content level is shown. FIG. 8 illustrates an embodiment in which an orientation X, Y of showing lists of at least one thumbnail image is alternating with respect to a subsequent content level of the thumbnail images. In case of showing thumbnail images belonging to digital objects of a plurality of content levels, a list of thumbnail images of a certain level may have only one digital object. In that case, this list may be skipped in displaying and the thumbnail images belonging to the digital objects of the next hierarchical content level may be shown. In a first example, a mailbox of a user contains one print job of five documents. The print job digital object level may be skipped and only the mailbox of the user at the mailbox level and the five documents at the document level may be displayed as a first and second scrollable list, respectively. In a second example, a mailbox of a user comprises only one print job of one document of six pages. The print job level and the document level may be skipped and only the mailbox of the user and the six pages of the document at the page level may be displayed as a first and second scrollable list, respectively.

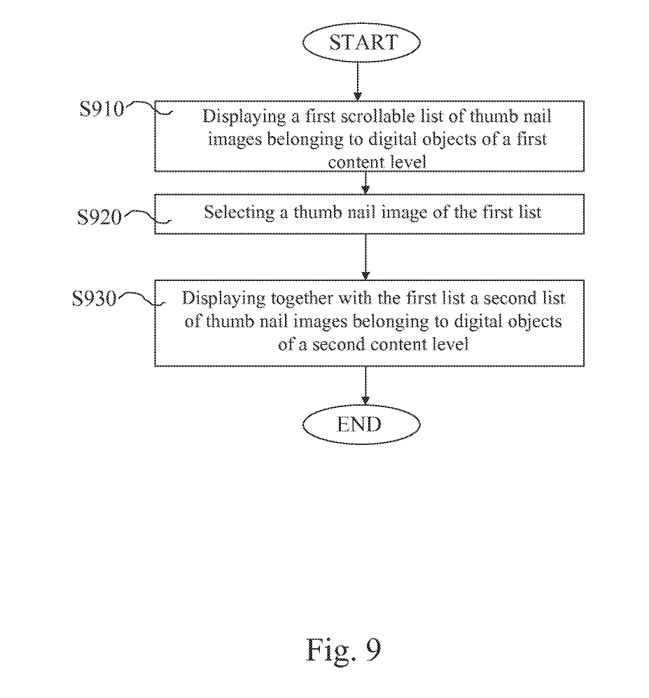

FIG. 9 is a flow diagram of an embodiment of the method according to the present invention. At the start of the method, the start screen of the user interaction system is opened. In a first step S910, a first scrollable list of thumbnail images representing digital objects characterized by a first content level is displayed. Each digital object of the first scrollable list comprises at least one digital object characterized by a second content level. In a second step S920, a digital object is selected from the first scrollable list by means of a user gesture at the first scrollable list. The user gesture may be a swiping gesture in a direction perpendicular to the longitudinal axis of the first scrollable list or a pointing gesture at a specific thumbnail image of the first scrollable list. According to an embodiment of the method, the swiping gesture may be used to scroll through the first scrollable list, and as soon as scrolling through the first scrollable list slows down, a thumbnail image of the first scrollable list may be snapped at. The thumbnail image that is in the middle of the visible thumbnail images of the first scrollable list may be snapped at. The thumbnail image that is snapped at is selected from the first scrollable list. In a third step S930, a second scrollable list of at least one thumbnail image is displayed simultaneously with the first scrollable list. The at least one thumbnail image of the second scrollable list corresponds to the at least one digital object characterized by the second content level, which at least one digital object corresponds to the selected digital object of the first scrollable list.

The second scrollable list is suitable to be tapped or clicked at or scrolled through in a similar manner as described hereinabove for the first scrollable list. From the second scrollable list, a thumbnail image may be selected in a similar manner as described hereinabove for the first scrollable list.

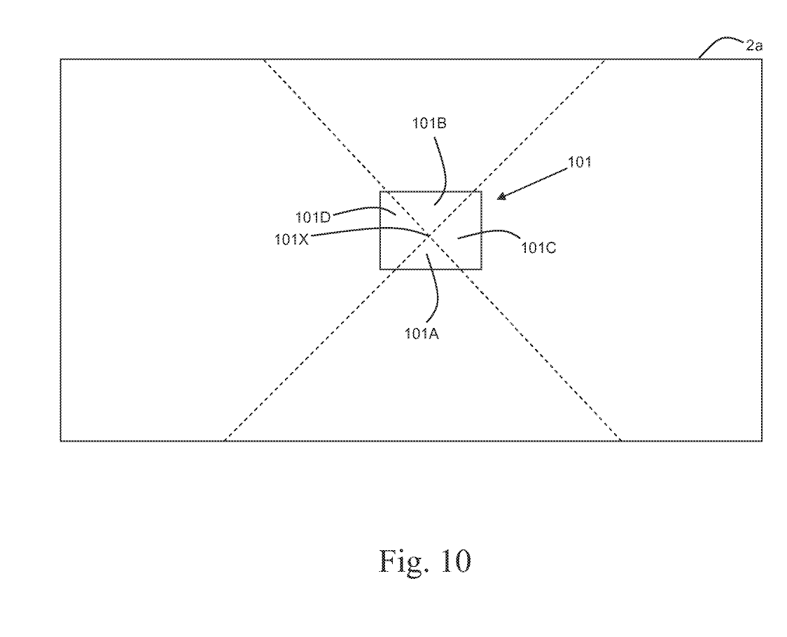

FIG. 10 illustrates a working area of a swiping gesture at a thumbnail image 101 in the part 2a of the display. The thumbnail image is part of a list of thumbnail images that are horizontally aligned. The thumbnail image represents a digital object at a first content level, which digital object comprises a list of digital objects at a second content level. For convenience reasons, the other thumbnail images in the list that are present in the part 2a are left out. A swiping gesture is applied upon the thumbnail image 101 at a location 101X within the thumbnail image 101. The area of the thumbnail image 101 is divided into four areas 101A, 101B, 101C, 101D by means of two perpendicular dashed auxiliary lines. In FIG. 10, the dashed lines are perpendicular, however, a set of dashed lines per swiping direction, which is to be distinguished and have another enclosing angle to determine the allowable swiping actions per swiping direction that is to be distinguished, is not excluded from the present invention.

The action following from the gesture depends on the direction of the swiping gesture. If the swiping gesture starts at the location 101X and extends in a left area 101D of the thumbnail image 101, the resulting action is a scrolling through the horizontal list of thumbnail images in a direction from a left end to a right end of the horizontal list.

If the swiping gesture starts at the location 101X and extends in a right area 101C of the thumbnail image 101, the resulting action is a scrolling through the horizontal list of thumbnail images in a direction from the right end to the left end of the horizontal list.

If the swiping gesture starts at the location 101X and extends in an upper area 101B of the thumbnail image 101 or in a lower area 101 A of the thumbnail image 101, the resulting action is an appearance of a second scrollable list of thumbnail items in a vertical direction through the location 101X. Each thumbnail image of the second scrollable list is representing a corresponding digital object of the second content belonging to the digital object at the first content level, which on its turn corresponds to the thumbnail image 101.

If the swiping gesture starts at the location 101X and extends in the upper area 101B of the thumbnail image 101, the resulting action is a scrolling through the vertical second scrollable list in a direction from an upper end to a lower end of the vertical list.

If the swiping gesture starts at the location 101X and extends in the lower area 101A of the thumbnail image 101, the resulting action is a scrolling through the vertical second scrollable list in a direction from the lower end to the upper end of the vertical list. An angle of crossing of the dashed auxiliary lines in FIG. 10 may depend on the aspect ratio of the thumbnail image 101.

In the previous figures, the first scrollable list is depicted as a horizontal list and the second scrollable list is depicted as a vertical list. However, it may be clear for the skilled person that other orientated first and second scrollable lists also fall under the scope of the present invention.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A user interaction system comprising:
a control for controlling digital objects of a first content level said digital objects comprising at least one digital object of a second content level; and
a display for displaying the digital objects of the first content level and the second content level by means of thumbnail images, said display being configured to display under control of the control:
a first scrollable list of at least one first selectable thumbnail image, each of the at least one first selectable thumbnail image representing a digital object of the first content level; and
a second scrollable list of at least one second selectable thumbnail image, each of the at least one second selectable thumbnail image representing a digital object of a second content level,
wherein the control is configured to issue a display command to the display to show the first scrollable list on the display and to show, upon selection of a thumbnail image of the first scrollable list, simultaneously with the first scrollable list, the second scrollable list corresponding to the at least one digital object of the second content level, the at least one digital object of the second content level being included in the digital object of the first content level and corresponding to the selected thumbnail image.

2. The user interaction system according to claim 1, wherein the first scrollable list and the second scrollable list are scrollable by means of a swiping gesture.

3. The user interaction system according to claim 1, wherein a first direction of scrolling through the first scrollable list and a second direction of scrolling through the second scrollable list have a same orientation.

4. The user interaction system according to claim 3, wherein the first scrollable list and the second scrollable list are positioned parallel and adjacent on the display.

5. The user interaction system according to claim 1, wherein a first direction of scrolling through the first scrollable list and a second direction of scrolling through the second scrollable list have a different orientation, and the second scrollable list, when shown, overlaps the first scrollable list at the thumbnail image selected from the first scrollable list.

6. The user interaction system according to claim 5, wherein the first direction is perpendicular to the second direction.

7. The user interaction system according to claim 5, wherein a thumbnail image is selected from the first scrollable list by swiping at the thumbnail image in the second direction.

8. The user interaction system according to claim 5, wherein the control is configured to issue a display command to the display in order to hide the second scrollable list when scrolling through the first scrollable list.

9. The user interaction system according to claim 1, wherein each digital object of the first content level and the second content level is one of a set of digital documents, a digital document, a chapter of a digital document and a page of a digital document.

10. The user interaction system according to claim 1, wherein the first content level of each digital object and the second content level of an at least one corresponding digital object are selected out of more than two content levels.

11. The user interaction system according to claim 10, wherein an orientation of showing lists of at least one thumbnail image alternates with respect to a subsequent content level of the digital objects corresponding to the lists of at least one thumbnail image.

12. A reproduction system comprising;
the user interaction system according to claim 9; and
a print engine, said print engine being controlled by the control of the user interaction system and being configured to reproduce the digital objects.

13. A method for scrolling through thumbnail images on a display of a user interaction system, each thumbnail image representing a digital object characterized by a content level out of a plurality of content levels, said method comprising the steps of:
displaying a first scrollable list of thumbnail images representing digital objects characterized by a first content level, each digital object comprising at least one digital object characterized by a second content level;
selecting a digital object from the first scrollable list by means of a user gesture at the first scrollable list; and
displaying simultaneously with the first scrollable list a second scrollable list of at least one thumbnail image corresponding to the at least one digital object characterized by the second content level, said at least one digital object corresponding to the selected digital object from the first scrollable list.

14. A computer executable program embodied on a non-transitory computer readable medium and configured to instruct a computer to perform the method according to claim 13.
